(19) United States
(12) Patent Application Publication
(10) Pub. No.: US 2018/0207842 A1
(43) Pub. Date: Jul. 26, 2018

(54) Remote Control Vehicle Accessory

(71) Applicant: Jason Phillip Gibson, Magnolia, TX (US)

(72) Inventor: Jason Phillip Gibson, Magnolia, TX (US)

(21) Appl. No.: 15/876,484

(22) Filed: Jan. 22, 2018

Related U.S. Application Data
(60) Provisional application No. 62/449,194, filed on Jan. 23, 2017.

(51) Int. Cl. B29C 33/62; B29C 33/58; C09D 175/02; B29C 37/00

(52) U.S. Cl. CPC B29C 33/62; B29C 33/58; A63H 17/004; B29C 37/0067; C09D 175/02

(57) ABSTRACT

A method for building a mold and building a protective skin on a premade body. The surface of the premade body can be sprayed with a mold release agent and then coated with bedliner material.

### NON-PROVISIONAL

This application is a non-provisional, and priority is hereby claimed to, U.S. provisional patent application having the Application No. 62/449,194, filed on Jan. 23, 2017. Accordingly, all disclosures, including figures and written material, made in the 62/449,194 provisional application are hereby incorporated by reference.

### BACKGROUND OF INVENTION

### Field of the Invention

The present invention relates generally to the field of remote control vehicles. More specifically, the present invention is a RC car/truck protective body.

### Background and Summary of the Invention

The present invention is a variety of RC car/truck bodies and protective body “skins” made using a Polyurea or polyurea hybrid similar to what's used in secondary containment coatings or truck bedliners. The prototypes are made from ultimate linings XT66 while using a high pressure plural component spray system and Quickliner when sprayed from a low-pressure cartridge system. The objective was to create a body or protective skin made 100% out of Bedliner for a more durable product that would survive crashes with nearly zero damage. Hobbyist spend $50-150 for a single body that could be ruined in a single crash. My product would be a money saver for those Who enjoy “free styling” or commonly known as “bashing” their RC's.

### DETAILED DESCRIPTION OF THE INVENTION

All illustrations of the drawings are for the purpose of describing selected versions of the present invention and are not intended to limit the scope of the present invention.

The process for building a “protective skin” is obtaining a desired premade body that the customer wishes to protect. The next step is to spray the exterior and interior with a mold release agent. I can then coat the outside or inside with a Bedliner material at approximately 20-60 mils thick. The coating has to be built up somewhat slowly using distance and pausing between recoats to not warp the original body or melt it. This results in a protective exterior skin or a strengthening interior skin that can be used until the customer wishes to peel it off of the original body. This would be considered a service to provide an add on or accessory for existing body designs owned by other companies.

To make a custom or completely new body, or any original design made out of 100% Bedliner material, I would utilize a mold process. Customers can send me their own designs of chopped up, blended, and reconstructed bodies or select from any of the original designs I offer. For the prototype, I used a random New Bright brand body to make a mold, but will have my own designs for production after testing the market with the “skins”. After developing a body, I would coat it inside and out with a mold release agent.

I would then spray the exterior with Bedliner material to approximately 30-60 mils and peel it off after letting it cure for a full 24 hrs to have a 100% Bedliner body or I can spray it 80-120 mils thick to make a reversed mold. After peeling the body out of the new thick shell, I can use that shell as a mold. It would simply require coating the inside and outer edges with a mold release agent before coating the inside with 3060 mils of Bedliner material.

Using the reverse mold will result in more crisp corners, details, and lines compared to just spraying the exterior for a final product. I've ran my prototype over with a forklift, lifted a 40 lb 6″ vise clamped to the opposite end, and froze it for 24 hrs before beating it with a hammer without suffering any damage. The bodies can also be made using a polyurea or polyurea hybrid with a mold injection process.

Although the invention has been explained in relation to its preferred embodiment, it is to be understood that many other possible modifications and variations can be made without departing from the spirit and scope of the invention.

1. A method for building a protective skin, comprising:
obtaining a premade body;
spraying an exterior surface and an interior surface of the body with a mold release agent; and
coating at least one of the exterior surface or interior surface with bedliner material.

2. The method of claim 1, wherein the coating of at least one of the exterior surface or interior surface is accomplished by one or more spray applications of the bedliner material to achieve a desired thickness.

3. The method of claim 1, further comprising allowing the bedliner material to cure for at least twenty-four hours.

4. The method of claim 1, wherein the bedliner material comprises polyurea.

5. The method of claim 1, wherein the bedliner material comprises a polyurea hybrid.

6. A method for building a protective skin, comprising:
spraying an exterior surface of a premade body with a mold release agent;
coating at least one of the exterior surface or interior surface with bedliner material; and
allowing the bedliner material to cure for at least twenty-four hours.

7. The method of claim 6, wherein the bedliner material comprises polyurea.

8. The method of claim 6, wherein the bedliner material comprises a polyurea hybrid.
